(19) United States
(12) Patent Application Publication
(10) Pub. No.: US 2026/0145331 A1
(43) Pub. Date: May 28, 2026

(54) SYSTEMS AND METHODS FOR HARDWARE-ENFORCED ROBOTIC ACTUATION CIRCUIT BREAKING WITH PROVENANCE PRESERVATION

(71) Applicant: George William Bickerstaff, III, Greenwich, CT (US)

(72) Inventor: George William Bickerstaff, III, Greenwich, CT (US)

(21) Appl. No.: 19/455,919

(22) Filed: Jan. 22, 2026

(51) Int. Cl. B25J 9/16

(52) U.S. Cl. CPC B25J 9/1664; G05B 2219/39001; G05B 2219/50193

(57) ABSTRACT

Systems and methods for hardware-enforced robotic actuation circuit breaking are disclosed. A trusted execution environment deterministically intervenes in physical actuation upon safety or compliance violations. Immutable provenance records preserve all intervention events for regulatory, legal, and insurance use.

### TECHNICAL FIELD

The present invention relates to robotic systems operating in regulated and safety-critical environments. More particularly, the invention relates to hardware-enforced circuit breaking of physical robotic actuation based on deterministic safety, compliance, and governance conditions, with immutable preservation of provenance data associated with intervention events.

### BACKGROUND

Robotic systems are increasingly deployed in environments where physical actuation may cause irreversible harm, including surgical procedures, autonomous vehicles, industrial automation, and critical infrastructure operations. Such systems often rely on software-based safety checks that may be bypassed, delayed, or rendered ineffective under fault, compromise, or emergent conditions.

Existing robotic safety mechanisms primarily depend on application-layer logic, sensor thresholds, or emergency stop inputs. These mechanisms do not provide deterministic, hardware-level enforcement capable of interrupting actuation in response to governance violations, policy breaches, or unexpected system behavior.

In regulated environments, it is insufficient to merely halt actuation. Regulators, insurers, operators, and courts require verifiable evidence describing why an intervention occurred, what signals triggered it, and what physical actions were prevented or altered as a result.

Accordingly, there exists a need for a hardware-enforced robotic actuation circuit breaker that operates independently of application software, deterministically intervenes in physical actuation, and preserves immutable provenance records describing all intervention events.

### SUMMARY

The disclosed invention provides systems and methods for hardware-enforced circuit breaking of robotic actuation with provenance preservation. A trusted execution environment monitors real-time robotic actuator commands and evaluates such commands against deterministic safety, compliance, and risk thresholds.

Upon detection of a violation, anomaly, or unauthorized condition, the circuit breaker deterministically interrupts, decelerates, or permanently disables physical actuation independent of application control. Intervention actions occur at a hardware boundary and cannot be overridden by higher-level software.

All intervention events, triggering conditions, enforcement actions, and resulting system states are recorded in immutable provenance records. These records are cryptographically verifiable and suitable for regulatory review, liability attribution, insurance underwriting, and post-incident analysis.

### DEFINITIONS

Actuation Command means any instruction causing physical movement, force application, or energy discharge by a robotic system.

Circuit Breaker means a hardware-enforced mechanism capable of interrupting or modifying physical actuation.

Governance Signal means a safety, compliance, or authorization input evaluated prior to actuation.

Hardware Boundary means a physical or trusted execution separation preventing software bypass.

Intervention Event means an actuation interruption, deceleration, disablement, or rollback.

Provenance Record means an immutable, cryptographically verifiable record of system events.

Risk Threshold means a deterministic boundary defining acceptable operational parameters.

Robotic Actuator means a physical component executing mechanical or energetic motion.

Safety Violation means a detected condition exceeding predefined operational limits.

Trusted Execution Environment means a protected hardware context isolated from application software.

### BRIEF DESCRIPTION OF THE DRAWINGS

FIG. 1—ROBOTIC ACTUATION ARCHITECTURE illustrates a hardware-enforced circuit breaker positioned between robotic control logic and physical actuators to prevent unauthorized or unsafe actuation.

FIG. 2—REAL-TIME COMMAND MONITORING illustrates deterministic interception and evaluation of robotic actuation commands prior to physical execution.

FIG. 3—CIRCUIT BREAKER INTERVENTION MODES illustrates hardware-level intervention responses including interruption, controlled deceleration, and permanent disablement.

FIG. 4—ESCALATION AND OVERRIDE CONTROL illustrates deterministic escalation, authorization validation, and controlled re-enablement following intervention events.

FIG. 5—PROVENANCE PRESERVATION AND USE illustrates immutable recording and downstream utilization of intervention provenance for regulatory, insurance, and forensic purposes.

### DETAILED DESCRIPTION OF THE DRAWINGS

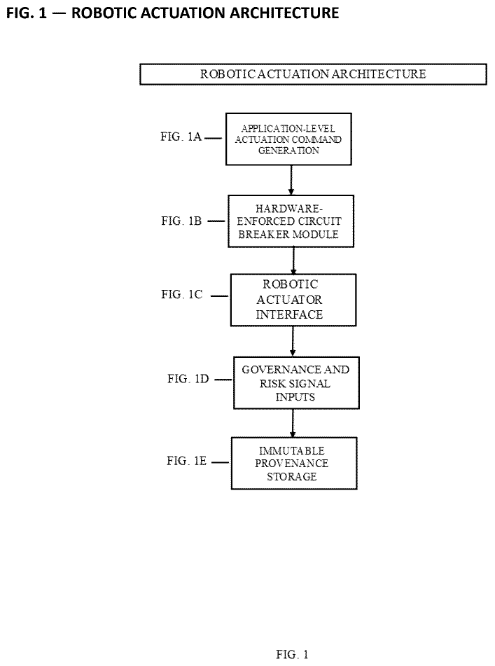

FIG. 1—ROBOTIC ACTUATION ARCHITECTURE

FIG. 1A—APPLICATION-LEVEL ACTUATION COMMAND GENERATION illustrates a robotic control stack generating actuation commands from application-level logic based on sensor data, planning algorithms, or operator input. Commands are produced without direct access to physical actuators. All commands are routed toward hardware-level enforcement.

FIG. 1B—HARDWARE-ENFORCED CIRCUIT BREAKER MODULE illustrates a hardware-isolated circuit breaker operating within a trusted execution environment. The circuit breaker evaluates actuation commands independently of application software. Bypass or modification by software processes is prevented.

FIG. 1C—ROBOTIC ACTUATOR INTERFACE illustrates robotic actuators receiving commands only after circuit breaker authorization. Physical movement occurs exclusively under permitted conditions. Unauthorized commands are blocked prior to actuation.

FIG. 1D—GOVERNANCE AND RISK SIGNAL INPUTS illustrates safety thresholds, authorization states, compliance rules, and contextual constraints supplied to the circuit breaker. Signals are evaluated deterministically in real time. Violations immediately trigger intervention.

FIG. 1E—IMMUTABLE PROVENANCE STORAGE illustrates immutable provenance storage coupled to the circuit breaker. All command evaluations and enforcement actions are recorded. Records persist independently of system state.

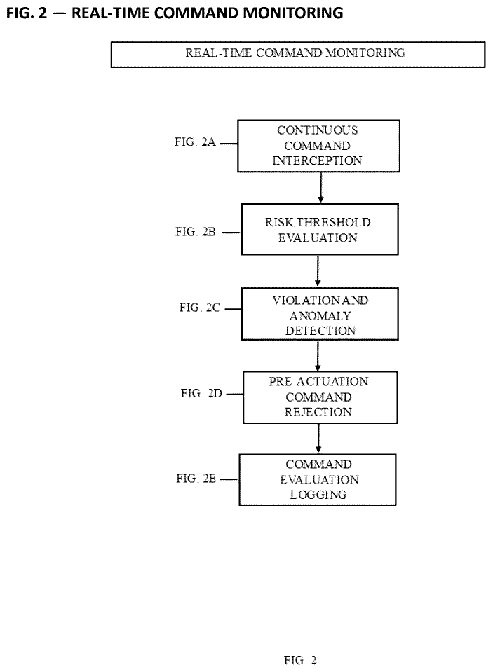

FIG. 2—REAL-TIME COMMAND MONITORING

FIG. 2A—CONTINUOUS COMMAND INTERCEPTION illustrates continuous interception of actuation commands prior to execution. Commands are captured at deterministic time intervals. No command bypasses evaluation.

FIG. 2B—RISK THRESHOLD EVALUATION illustrates evaluation of intercepted commands against predefined deterministic risk thresholds. Thresholds may include force, velocity, trajectory, and contextual parameters. Evaluation is non-probabilistic.

FIG. 2C—VIOLATION AND ANOMALY DETECTION illustrates detection of safety violations or anomalous command behavior. Violations may arise from unauthorized sources or unexpected system states. Detection immediately triggers intervention logic.

FIG. 2D—PRE-ACTUATION COMMAND REJECTION illustrates rejection of unsafe commands prior to physical actuation. Rejected commands do not propagate to actuators. Physical safety is preserved.

FIG. 2E—COMMAND EVALUATION LOGGING illustrates logging of all evaluated commands regardless of outcome. Both permitted and rejected commands are immutably recorded. Complete forensic reconstruction is supported.

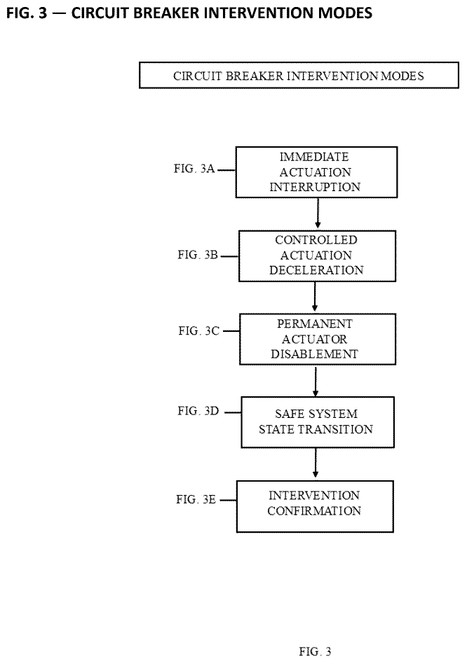

FIG. 3—CIRCUIT BREAKER INTERVENTION MODES

FIG. 3A—IMMEDIATE ACTUATION INTERRUPTION illustrates deterministic interruption of actuation at the hardware boundary. Electrical or logical pathways are severed. Intervention is immediate.

FIG. 3B—CONTROLLED ACTUATION DECELERATION illustrates controlled deceleration of robotic motion. Motion is reduced to a safe state rather than abruptly halted. Secondary hazards are avoided.

FIG. 3C—PERMANENT ACTUATOR DISABLEMENT illustrates permanent actuator disablement following severe or repeated violations. Disablement prevents further motion. Recovery requires authorized reset.

FIG. 3D—SAFE SYSTEM STATE TRANSITION illustrates transition to a defined safe system state following intervention. Actuators remain inactive pending resolution. System integrity is maintained.

FIG. 3E—INTERVENTION CONFIRMATION illustrates verification that intervention actions were successfully executed. Actuation status is confirmed post-intervention. Results are immutably logged.

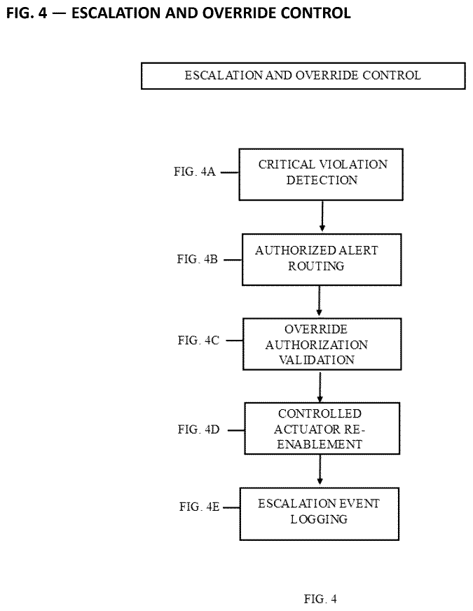

FIG. 4—ESCALATION AND OVERRIDE CONTROL

FIG. 4A—CRITICAL VIOLATION DETECTION illustrates detection of repeated or critical violations. Escalation thresholds are evaluated deterministically. Manual oversight may be required.

FIG. 4B—AUTHORIZED ALERT ROUTING illustrates routing of alerts to authorized personnel. Alerts include contextual and provenance data. Operators receive actionable information.

FIG. 4C—OVERRIDE AUTHORIZATION VALIDATION illustrates validation of override authorization. Overrides require verified credentials. Unauthorized overrides are rejected.

FIG. 4D—CONTROLLED ACTUATOR RE-ENABLEMENT illustrates controlled re-enablement of actuators following authorization. Safety conditions are revalidated. Actuation resumes only within approved constraints.

FIG. 4E—ESCALATION EVENT LOGGING illustrates immutable logging of escalation and override events. All attempts and outcomes are recorded. Accountability is preserved.

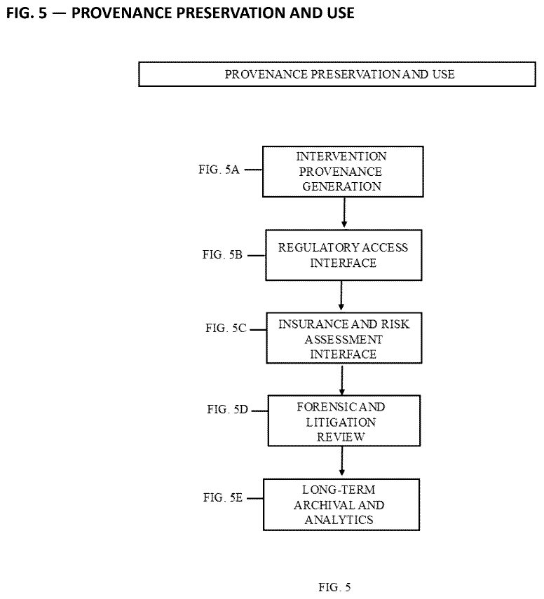

FIG. 5—PROVENANCE PRESERVATION AND USE

FIG. 5A—Intervention Provenance Generation Illustrates generation of provenance records for each intervention event. Records include trigger conditions and enforcement actions. Cryptographic signatures ensure integrity.

FIG. 5B—REGULATORY ACCESS INTERFACE illustrates regulator access to provenance data. Access does not modify records. Independent verification is supported.

FIG. 5C—INSURANCE AND RISK ASSESSMENT INTERFACE illustrates insurer utilization of provenance records. Records inform underwriting and claims decisions. Dynamic risk models are supported.

FIG. 5D—FORENSIC AND LITIGATION REVIEW illustrates forensic and litigation analysis using provenance records. Records provide authoritative timelines. Evidentiary integrity is preserved.

FIG. 5E—LONG-TERM ARCHIVAL AND ANALYTICS illustrates long-term archival and analytics of provenance data. Records support safety improvement initiatives. Authenticity remains verifiable.

### EXAMPLES

### Example 1—Surgical Force Violation

During a robotic surgical procedure, an actuator command exceeds predefined force limits. The circuit breaker interrupts actuation before tissue damage occurs. The intervention is recorded with full provenance context.

### Example 2—Unauthorized Industrial Command

A compromised application attempts to issue an unauthorized motion command. The hardware circuit breaker blocks execution and disables the actuator. Provenance records support investigation and attribution.

1. A system for robotic actuation safety, comprising:
a hardware-enforced circuit breaker operating within a trusted execution environment;
a real-time command monitoring module evaluating actuation commands against deterministic risk thresholds; and
a physical intervention mechanism configured to interrupt, decelerate, or disable robotic actuation independent of application software.

2. A computer-implemented method comprising:
monitoring robotic actuation commands at a hardware boundary;
evaluating the commands against predefined safety or compliance thresholds;
deterministically intervening in physical actuation upon violation; and
recording immutable provenance describing the intervention event.

3. A non-transitory computer-readable medium storing instructions that,
when executed by a trusted execution environment, cause the system to perform the method of claim 2.

4. The system of claim 1, wherein the intervention includes controlled deceleration.

5. The system of claim 1, wherein the intervention includes permanent actuator disablement.

6. The system of claim 1, further comprising immutable provenance storage.

7. The method of claim 2, wherein violations include unauthorized command sources.

8. The method of claim 2, wherein escalation requires verified human authorization.

9. The system of claim 1, wherein provenance records are cryptographically signed.

10. The non-transitory computer-readable medium of claim 3, further storing instructions for regulatory audit access.
